(19) United States
(12) Patent Application Publication
(10) Pub. No.: US 2001/0022447 A1
(43) Pub. Date: Sep. 20, 2001

(54) Postal article

(76) Inventor: John Calvert Tait, Victoria (AU)

Correspondence Address: LYON & LYON LLP, SUITE 4700, 633 WEST FIFTH STREET, LOS ANGELES, CA, 90071-2066, US

(21) Appl. No.: 09/780,580

(22) Filed: Feb. 9, 2001

(30) Foreign Application Priority Data
Feb. 9, 2000 (AU) PQ5510

(51) Int. Cl. G09F 3/00

(52) U.S. Cl. 283/71

(57) ABSTRACT

A postal item such as an envelope or courier pack. The postal item has a sheet providing an outer surface. The sheet is provided with removable tags that when removed provide openings in the sheet. A backing sheet or sheets close the opening so formed.

### TECHNICAL FIELD

The present invention relates to postal items such as envelopes and courier packs.

### BACKGROUND OF THE INVENTION

Where postal items such as envelopes and courier packs are picked up and delivered, separate paperwork is generally provided and completed at the dispatch end and the receiving end. This system is generally inconvenient and can sometimes be unreliable in respect of correctly recording pick-up and delivery. This unreliability can also result in difficulty tracking the postal item during the delivery process.

### OBJECT OF THE INVENTION

It is the object of the present invention to overcome or substantially ameliorate the above disadvantage.

### SUMMARY OF THE INVENTION

There is disclosed herein a postal item including:

a sheet providing an outlet face and an inner face, said sheeting having at least one removable portion which when removed provides an opening in said sheet; and

a backing sheet secured to said inner face to close said opening when said removable portion is removed.

Preferably there are at least two removable portions so that two openings are provided in said sheet when the removable portions are removed, with said backing sheet covering both openings when said removable portions are removed.

Preferably said backing sheet and adhesive engage each removable portion to inhibit unintentional removal of the removable portion.

Preferably the postal item is a courier pack or envelope.

### BRIEF DESCRIPTION OF THE DRAWINGS

A preferred form of the present invention will now be described by way of example with reference to the accompanying drawings wherein:

FIG. 1 is a schematic elevation of the front of an envelope;

FIG. 2 is a schematic elevation of the rear of the front sheet of the envelope of FIG. 1;

FIG. 3 is a schematic further elevation of the rear of the front sheet;

FIG. 4 is a schematic section side elevation of a backing sheet employed in the envelope of FIG. 1; and

FIG. 5 is a schematic elevation of the rear of the front sheet of FIG. 2.

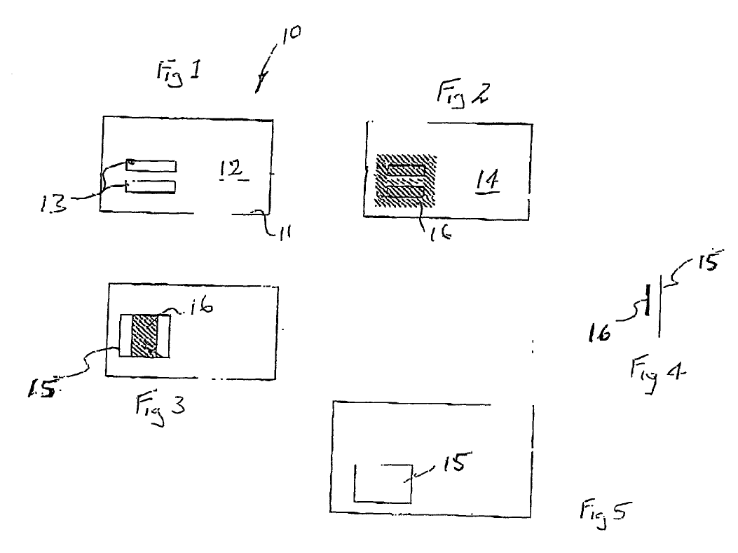

### DETAILED DESCRIPTION OF THE PREFERRED EMBODIMENTS

In the accompanying drawings there is schematically depicted a postal item 10 which may be an envelope or courier pack 10. The postal item 10 has a sheet 11 providing the outer front face 12 of the item 10. The sheet 11 is provided with removable tags 13. For example, the tags 13 might be defined by lines of perforations or may be cut along the lines illustrated so as to be separated from the remainder of the sheet 11.

The sheet 11 has an inner face 14 to which there is applied a backing sheet 15. The backing sheet 15 is provided with an adhesive 16 applied thereto. When the backing sheet 15 and adhesive applied thereto is applied to the inner face 14, the adhesive 16 would surround and more preferably cover the rear of the tags 13. Accordingly, the backing sheet 15 covers any apertures that may be formed when the tags 13 are removed. Still further, the backing sheet 15 and adhesive 16 may aid in retaining the tags 13 in position to thereby inhibit unintentional removal.

The sheet 15 may be transparent or opaque.

The above-described postal item 10 by providing tags 13, enables the sender to record dispatch of the document by removing one of the tags. A tag may also be removed to effectively “cancel” the “postage” (payment) for prepaid products.

Preferably the backing sheet 15 would have a silicone coating to which the adhesive is applied. The silicone layer would not cover the periphery of the sheet 15 so that the sheet 15 would be secured to the face 14. In a further embodiment the adhesive could first be applied to the face 14 and the sheet 15 applied thereto.

What is claimed is:

1. A postal item comprising
a sheet providing an outer surface and an inner surface, said sheet having at least one removable portion which when removed provides an opening in said sheet; and
a backing sheet secured to said inner surface to close said opening when said removable portion is removed.

2. The postal item of claim 1 wherein there are at least two removable portions so that two openings are provided in said sheet when the removable portions are removed, with said backing sheet covering both openings when said removable portions are removed.

3. The postal item of claim 2 wherein said backing sheet and an adhesive engage each removable portion to inhibit unintentional removal of the removable portion or portions.

4. The postal item of claim 3 wherein said postal item is a courier pack or envelope.

5. The postal item of claim 2 wherein said postal item is a courier pack or envelope.

6. The postal item of claim 1 wherein said backing sheet and an adhesive engage each removable portion to inhibit unintentional removal of the removable portion or portions.

7. The postal item of claim 6 wherein said postal item is a courier pack or envelope.

8. The postal item of claim 1 wherein said postal item is a courier pack or envelope.
